(19) United States
(12) Patent Application Publication
(10) Pub. No.: US 2023/0074779 A1
(43) Pub. Date: Mar. 9, 2023

(54) SERVICE RELATIONS IN PROVISIONING OF COMMUNICATION SERVICE INSTANCE

(71) Applicant: Telefonaktiebolaget LM Ericsson (publ), Stockholm (SE)

(72) Inventors: Paul STJERNHOLM, LIDINGÖ (SE); Oscar ZEE, STOCKHOLM (SE); Stefan BERGLUND, STOCKHOLM (SE)

(21) Appl. No.: 17/799,649

(22) PCT Filed: Feb. 5, 2021
(86) PCT No.: PCT/EP2021/052812

§ 371 Date: Aug. 12, 2022

Related U.S. Application Data
(60) Provisional application No. 62/976,124, filed on Feb. 13, 2020.

(51) Int. Cl. H04W 16/10

(52) U.S. Cl. CPC H04W 16/10

(57) ABSTRACT

A method of provisioning a communication service instance to a customer. The method performed at a network slice management function, NSMF, comprises receiving from a communications service management function, CSMF, a first message requesting an operation on at least one network slice instance, NSI. The first message comprises attributes and their values defining at least one service profile. The method further comprises sending to a network slice subnet management function, NSSMF, a second message requesting an operation on at least one network slice subnet instance, NSSI. The second message comprises attributes and their values defining at least one slice profile, wherein the at least one slice profile is based on attributes and their values defining profiles of at least one customer facing service, CFS, and at least one resource facing service, RFS, associated with said at least one customer facing service, CFS.

### TECHNICAL FIELD

The present disclosure relates to network slicing, in general, and in particular to methods and network elements for provisioning a communication service instance to a customer.

### BACKGROUND

Telecom Management Forum (TMF) specifies in GB922 Service Overview that the expected quality of a certain service should be defined by one or several associated Service Level Specification. The GB922 Service Overview also shows that a service can be divided into subtypes known as Customer Facing Service (CFS) and Resource Facing Service (RFS). Furthermore, the same document also shows that many CFS can be associated with many RFS through the relation CFServiceRequiresRFServices. The subtypes of services and their relationship are illustrated in FIGS. 1 and 2 reproduced from the GB922 document.

On the other hand, 3GPP defines a Network Resource Model (NRM) in 3GPP TS 28.541 in which a Network Slice is a part. A Network Slice is associated with one or more Service Profiles defining the service level requirements to be provided by an instance of the Network Slice (NS), a Network Slice Instance (NSI). Furthermore, an NSI may be subdivided into one or more Network Slice Subnet Instances (NSSI), where each NSSI is associated with one or more Slice Profiles holding information on the corresponding service level requirements. This relationship of a network slice in a network resource model is illustrated in FIG. 3 reproduced from 3GPP TS 28.541.

In yet another 3GPP standard, 3GPP TS 28.530, the relation between Communication Service Instance (CSI) and corresponding Network Slice Instances (NSIs) is explained. It indicates that a CSI may be associated with more than one NSI and that an NSI may be associated with more than one CSI, as illustrated in FIG. 4 reproduced from 3GPP TS 28.530. The CSI may be related to the Resource Facing Service (RFS) and its associated Customer Facing Service (CFS) defined by the TMF. According to 3GPP TR 28.805, the CSI is meant to relate to the Resource Facing Service (RFS) and its associated Customer Facing Service (CFS) defined by the TMF. An example of this relationship is shown in FIG. 5 reproduced from 3GPP TR 28.805.

### SUMMARY

The solution disclosed in this document enables defining relations between services as well as between services and user equipment to accurately automate creation and modification of network slices and network slice subnets and enable configuration of multiple slices associated with the same UE, which is not possible in solutions defined in current standard specifications.

According to a first aspect of the disclosed solution there is provided a method of provisioning a communication service instance to a customer. The method performed at a network slice management function, NSMF, comprises receiving from a communications service management function, CSMF, a first message requesting an operation on at least one network slice instance, NSI. The first message comprises attributes and their values defining at least one service profile. The method further comprises sending to a network slice subnet management function, NSSMF, a second message requesting an operation on at least one network slice subnet instance, NSSI. The second message comprises attributes and their values defining at least one slice profile, wherein the at least one slice profile is based on attributes and their values defining profiles of at least one customer facing service, CFS, and at least one resource facing service, RFS, associated with said at least one customer facing service, CFS.

According to a second aspect of the disclosed solution there is provided a method of provisioning a communication service instance to a customer. The method performed at a communications service management function, CSMF, comprises sending to a network slice management function, NSMF, a first message requesting an operation on at least one network slice instance, NSI. The first message comprises attributes and their values defining at least one customer facing service, CFS, and at least one resource facing service, RFS, associated with said at least one customer facing service, CFS.

According to a third aspect of the disclosed solution there is provided a method of provisioning a communication service instance to a customer. The method performed at a network slice subnet management function, NSSMF, comprises receiving from a network slice management function, NSMF, a second message requesting an operation on at least one network slice subnet instance, NSSI. The second message comprises attributes and their values defining at least one slice profile, wherein the at least one slice profile is based on attributes and their values defining profiles of at least one customer facing service, CFS, and at least one resource facing service, RFS, associated with said at least one customer facing service, CFS. The method further comprises performing the requested operation on the at least one network slice subnet instance, NSSI, using the attributes and their values defining the at least one slice profile identified in the second message.

According to a fourth aspect of the disclosed solution there is provided a first network element for implementing a network slice management function, NSMF. The first network element comprises a processing circuitry and a memory. The memory contains instructions executable by the processing circuitry such that the first network element is operative to receive from a communications service management function, CSMF, a first message requesting an operation on at least one network slice instance, NSI. The first message comprises attributes and their values defining at least one service profile. The first network element is operative to send to a network slice subnet management function, NSSMF, a second message requesting an operation on at least one network slice subnet instance, NSSI. The second message comprises attributes and their values defining at least one slice profile. The at least one slice profile is based on attributes and their values defining profiles of at least one customer facing service, CFS, and at least one resource facing service, RFS, associated with said at least one customer facing service, CFS.

According to a fifth aspect of the disclosed solution there is provided a second network element for implementing a communications service management function, CSMF. The second network element comprises a processing circuitry and a memory. The memory contains instructions executable by the processing circuitry such that the second network element is operative to send to a network slice management function, NSMF, a first message requesting an operation on at least one network slice instance, NSI. The first message comprises attributes and their values defining at least one customer facing service, CFS, and at least one resource facing service, RFS, associated with said at least one customer facing service, CFS.

According to a sixth aspect of the disclosed solution there is provided a third network element for implementing a network slice subnet management function, NSSMF. The third network element comprises a processing circuitry and a memory. The memory contains instructions executable by the processing circuitry such that the third network element is operative to receive from a network slice management function, NSMF, a second message requesting an operation on at least one network slice subnet instance, NSSI. The second message comprises attributes and their values defining at least one slice profile. The at least one slice profile is based on attributes and their values defining profiles of at least one customer facing service, CFS, and at least one resource facing service, RFS, associated with said at least one customer facing service, CFS. The third network element is further operative to perform the requested operation on the at least one network slice subnet instance, NSSI, using the attributes and their values defining the at least one slice profile identified in the second message.

According to a seventh aspect of the disclosed solution there is provided a computer program comprising instructions which, when executed on at least one processor, cause the at least one processor to carry out a method according to embodiments disclosed in this document.

According to an eight aspect of the disclosed solution there is provided a carrier containing a computer program disclosed earlier, wherein the carrier comprises one of an electronic signal, optical signal, radio signal or computer readable storage medium.

According to a ninth aspect of the disclosed solution there is provided a computer program product comprising non transitory computer readable media having stored thereon a computer program disclosed earlier.

According to a tenth aspect of the disclosed solution there is provided a network comprising a first network element, a second network element and a third network element as disclosed in this document, wherein the first network element, the second network element and the third network element are operative to perform the methods as disclosed in this document.

According to an eleventh aspect of the disclosed solution there is provided a method of provisioning a communication service instance to a customer. The method performed at a network slice management function, NSMF, comprises receiving from a communications service management function, CSMF, a third message requesting an operation on at least one existing network slice instance, NSI. The third message comprises attributes and their values defining at least one service profile to be associated with the at least one existing network slice instance, NSI. The method also comprises associating the at least one service profile with the at least one existing network slice instance, NSI, and sending to a network slice subnet management function, NSSMF, a fourth message requesting an operation on at least one existing network slice subnet instance, NSSI. The fourth message comprises attributes and their values defining at least one slice profile to be associated with the at least one existing network slice subnet instance, NSSI. The at least one slice profile is based on attributes and their values defining profiles of at least one customer facing service, CFS, and at least one resource facing service, RFS, associated with said at least one customer facing service, CFS.

According to a twelfth aspect of the disclosed solution there is provided a first network element for implementing a network slice management function, NSMF. The first network element comprises a processing circuitry and a memory, the memory contains instructions executable by the processing circuitry such that the first network element is operative to receive from a communications service management function, CSMF, a third message requesting an operation on at least one existing network slice instance, NSI. The third message comprises attributes and their values defining at least one service profile to be associated with the at least one existing network slice instance, NSI. The first network element is further operative to associate the at least one service profile with the at least one existing network slice instance, NSI, and to send to a network slice subnet management function, NSSMF, a fourth message requesting an operation on at least one existing network slice subnet instance, NSSI. The fourth message comprises attributes and their values defining at least one slice profile to be associated with the at least one existing network slice subnet instance, NSSI. The at least one slice profile is based on attributes and their values defining profiles of at least one customer facing service, CFS, and at least one resource facing service, RFS, associated with said at least one customer facing service, CFS.

The disclosed solution provides the advantage over earlier solutions that it allows for defining relations between services and between services and user equipment to accurately automate creation and modification of network slices and network slice subnets, and this, in turn, enables configuration of multiple slices associated with the same UE, which is not possible in current specifications.

### BRIEF DESCRIPTION OF THE DRAWINGS

The disclosed solution will be understood and appreciated more fully from the following detailed description taken in conjunction with the drawings in which:

FIG. 1 to FIG. 5 are diagrams illustrating background solutions helpful in understanding the solution now to be disclosed;

FIG. 6 is a diagram illustrating message flow between network functions;

FIG. 7(a) to FIG. 7(c) are diagrams illustrating examples of relations between Customer Facing Services, Resource Facing Services and User Equipment;

FIG. 8 to FIG. 12 are diagrams illustrating embodiments of methods disclosed in this document;

FIG. 13 to FIG. 15 are diagrams illustrating embodiments of network elements disclosed in this document.

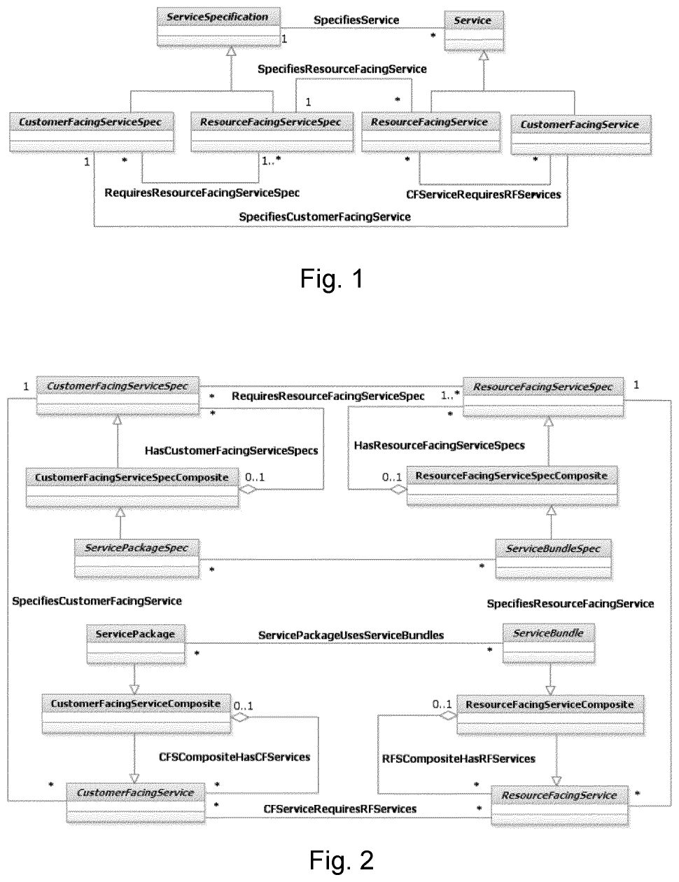

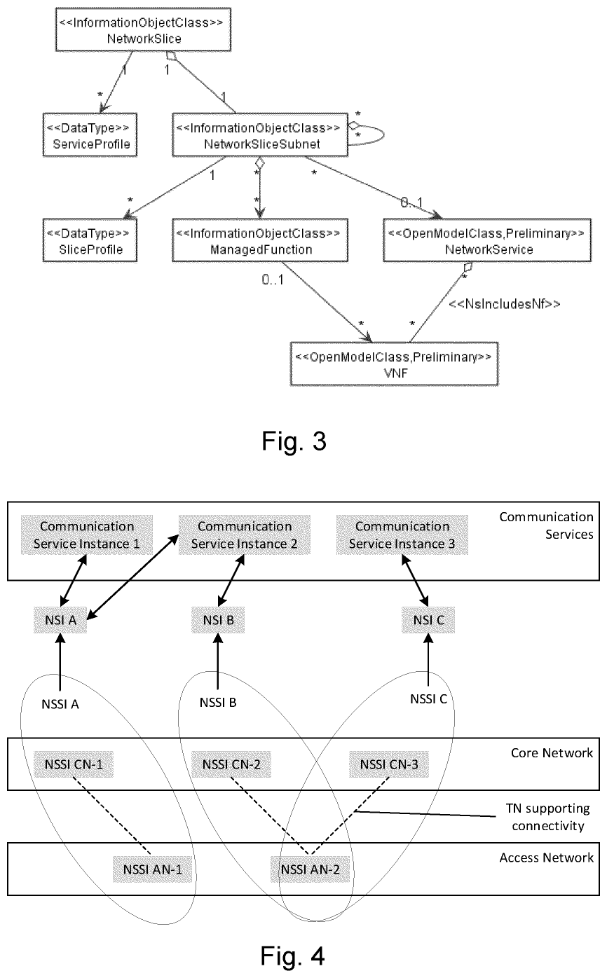

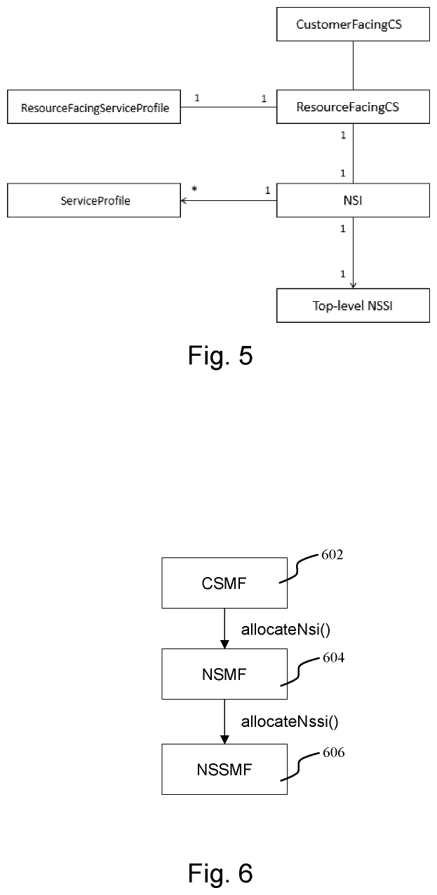

### DETAILED DESCRIPTION

In the following description, for purposes of explanation and not limitation, specific details are set forth such as particular architectures, interfaces, techniques, etc. in order to provide a thorough understanding of the disclosed solution. However, it will be apparent to those skilled in the art that the disclosed solution may be practiced in other embodiments that depart from these specific details. In other instances, detailed descriptions of well-known devices, circuits, and methods are omitted so as not to obscure the description of the solution with unnecessary details.

Reference throughout the specification to “one embodiment” or “an embodiment” means that a particular feature, structure, or characteristic described in connection with an embodiment is included in at least one embodiment of the present disclosure. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

The authors realised that in a Service Profile associated with a particular Network Slice, as defined in 3GPP TS 28.541 (ServiceProfile <<dataType>>), only one service is identified. As explained earlier, the Customer Facing Services and Resource Facing Services may be associated with one another and delivering a service to a wireless device (e.g. User Equipment, UE) may require using several associated CFS and RFS. The specification 3GPP TS 28.541 does not define the CFS and RFS as part of a Service Profile and, thus, the 3GPP TS 28.531, on Management and orchestration — Provisioning, does not define the associated RFS and CFS as part of the AllocateNsi or AllocateNssi procedures, when creating an NSI and NSSI respectively (defined in 3GPP TS 28.531 V16.4.0 clauses 6.5.1 and 6.5.2).

A service to be delivered to a wireless device (e.g. to a user equipment) may have its associated Service Level Agreement (SLA) negotiated between a provider of the service and a Communication Service Management Function (CSMF). The SLA is a commercial agreement between the service provider and a service consumer, that may serve as input to the CSMF. It needs, in turn, to be translated into technical service requirements manifested in e.g. ServiceLevelSpecifications (TMF) and ServiceProfiles (3GPP), that can be interpreted by the system. The negotiation of the SLA is known in the art and will not be discussed in this document.

As illustrated in FIG. 6, once the SLA is negotiated the CSMF, 602, may communicate with a Network Slice Management Function (NSMF), 604, to secure network resources (physical as well as virtual resources) necessary for delivering the service and to create a ServiceProfile. As explained below, the task of securing network resources for the services is delegated to a Network Slice Subnet Management Function (NSSMF). To achieve this, the CSMF, 602, sends an AllocateNsi() message to the NSMF, 604, to allocate a network slice instance (NSI) to the service. The NSMF, 604, may implement this NSI either by creating a new network slice instance or by modifying an existing one. Please note that based on the negotiated SLA the CSMF may request an exclusive use of an NSI for the service, however the CSMF cannot directly control the creation of NSIs, since it's the task of the NSMF. In this embodiment, if a service is defined as non-sharable when allocating an NSI, a new NSI could be created by the NSMF. The AllocateNsi() message carries as input parameters a list of attributes given as key value pairs, i.e. {key, value}, which specify the network slice related requirements defined in ServiceProfile. Based on the received AllocateNsi() message the NSMF, 604, in turn, sends an AllocateNssi() message to a Network Slice Subnet Management Function (NSSMF), 606. Then, in turn, the NSSMF, 606, may allocate one or more Network Slice Subnet Instances (NSSIs) to provide the resources requested for deploying the service. Similar to the NSMF, 604, also the NSSMF, 606, may create a new NSSI(s) or modify existing one(s). In allocating one or more NSSIs, the NSSMF, 606, creates a SliceProfile and associates with it the new or existing NSSI(s). Similar to the AllocateNsi() message also the AllocateNssi() message carries as input parameters a list of attributes given as key value pairs, i.e. {key, value}. In the AllocateNssi() message the input parameters specify the network slice subnet related requirements defined in a SliceProfile.

However, because the information included in the AllocateNsi() message specify requirements defined in ServiceProfile for only the requested service (the one for which the SLA was negotiated), the Customer Facing Services and Resource Facing Services associated with the requested service are not considered by the NSMF, 604, and in consequence by the NSSMF, 606, in defining the profile of the network slice, SliceProfile.

The authors realised that it would be advantageous to include this information when creating subsequent Network Slice Subnet Instances (NSSI), since the control plane of services defined by Service Profiles associated with the same CFS must be served by the same control plane network functions if they are connected via the same radio modem on the user side, i.e. the same wireless device (UE). In general, it holds that services to be used simultaneously by a user equipment need to be associated with the same NSSI for the control plane.

The problem addressed by this disclosure is how to relate a Customer Facing Service and a Resource Facing Service, consumed by the same wireless device (e.g. user equipment), to a Service Profile of a Network Slice Instance and a Slice Profile of a Network Slice Subnet Instance, and how to convey this information when creating and/or modifying a Network Slice Instance and a Network Slice Subnet Instance.

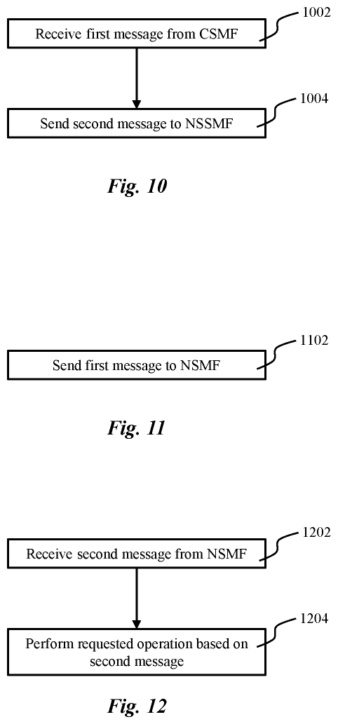

FIG. 10 illustrates one embodiment of a method of provisioning a communication service instance to a customer. The method, in a preferred embodiment, may be performed at a network slice management function, NSMF, 604 and may comprise receiving 1002 from a communications service management function, CSMF, 602 a first message requesting an operation on at least one network slice instance, NSI. The first message comprises attributes and their values defining at least one service profile. The method further comprises sending 1004 to a network slice subnet management function, NSSMF, 606 a second message requesting an operation on at least one network slice subnet instance, NSSI. The second message comprises attributes and their values defining at least one slice profile. The at least one slice profile is based on attributes and their values defining profiles of at least one customer facing service, CFS, and at least one resource facing service, RFS, associated with said at least one customer facing service, CFS.

In a preferred embodiment the operation on a network slice instance, NSI, may comprise an operation of allocating a new network slice instance or an operation of modifying an existing network slice instance. The operation of allocating a new network slice instance may be realised in practice by the AllocateNsi procedure defined in 3GPP TS 28.531 and further specified in this document. The operation of modifying an existing network slice instance may be realised in practice by the ModidyNsi procedure mentioned in 3GPP TS 28.531 and further specified in the present disclosure.

In a preferred embodiment the operation on a network slice subnet instance, NSSI, comprises an operation of allocating a new network slice subnet instance or an operation of modifying an existing network slice subnet instance. Similarly, the operation of allocating a new network slice subnet instance may be realised in practice by the AllocateNssi procedure defined in 3GPP TS 28.531 and further specified in this document, whereas the operation of modifying an existing network slice subnet instance may be realised in practice by the ModidyNssi procedure mentioned in 3GPP TS 28.531 and further specified in the present disclosure.

Preferably, also the first message comprises attributes and their values defining at least one customer facing service, CFS, and at least one resource facing service, RFS, associated with said at least one customer facing service, CFS.

In a preferred embodiment said first message may further comprise an identifier indictive of a User Equipment consuming said at least one customer facing service, CFS, and its associated at least one resource facing service, RFS. And in a further preferred embodiment the at least one slice profile is also based on an identifier indicative of a User Equipment consuming said at least one customer facing service, CFS, and its associated at least one resource facing service, RFS.

FIG. 11 illustrates one embodiment of a method of provisioning a communication service instance to a customer performed at a communications service management function, CSMF, 602. In a preferred embodiment the method comprises sending 1102 to a network slice management function, NSMF, 604 a first message requesting an operation on at least one network slice instance, NSI. The first message preferably comprises attributes and their values defining at least one customer facing service, CFS, and at least one resource facing service, RFS, associated with said at least one customer facing service, CFS.

In a further preferred embodiment, said first message may comprise an identifier indicative of a User Equipment consuming said at least one customer facing service, CFS, and its associated at least one resource facing service, RFS. As discussed later in this disclosure, the identifier indicative of a User Equipment (UEid) may be denoted Userld or similar assuming that the user uses one UE.

As discussed earlier, the operation on a network slice instance, NSI, may comprise an operation of allocating a new network slice instance (using the AllocateNsi procedure) or an operation of modifying an existing network slice instance (using the ModifyNsi procedure).

With reference to FIG. 12 one embodiment of a method of provisioning a communication service instance to a customer performed at a network slice subnet management function, NSSMF, 606 is now to be described. The method, preferably comprises receiving 1202 from a network slice management function, NSMF, 604 a second message requesting an operation on at least one network slice subnet instance, NSSI. The second message preferably comprises attributes and their values defining at least one slice profile, wherein the at least one slice profile is based on attributes and their values defining profiles of at least one customer facing service, CFS, and at least one resource facing service, RFS, associated with said at least one customer facing service, CFS. The method, preferably, also comprises performing 1204 the requested operation on the at least one network slice subnet instance, NSSI, using the attributes and their values defining the at least one slice profile identified in the second message.

In a preferred embodiment the operation on a network slice subnet instance, NSSI, comprises an operation of allocating a new network slice subnet instance (using the AllocateNssi procedure) or an operation of modifying an existing network slice subnet instance (using the ModifyNssi procedure).

In a further preferred embodiment, the at least one slice profile is also based on an identifier indicative of a User Equipment consuming said at least one customer facing service, CFS, and its associated at least one resource facing service, RFS.

In the embodiments described in this disclosure the first message may comprise an AllocateNsi() message or a ModifiNsi() message and, similarly, the second message may comprise an AllocateNssi() message or aModifyNssi() message.

Further details of the various embodiments will be described below.

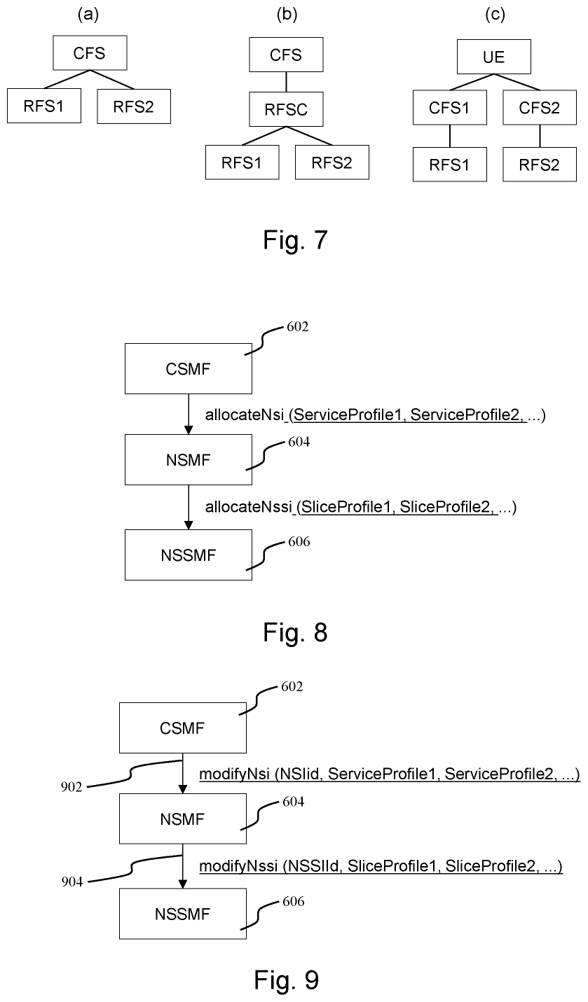

FIG. 7 illustrates three examples of relations between CFS and RFS, in practice, there may be more CFS and RFS participating in these relations, but for brevity only these three are now illustrated and described. In the example shown in FIG. 7(a), the CFS consists of two RFSs. In the example shown in FIG. 7(b) the CFS is associated with a Composite RFS (RFSC) consisting of two RFSs. The RFSC is defined by TMF as modelled in FIG. 2. In the example shown in FIG. 7(c) the two CFS are associated with a common UE, providing the service.

A unique identity of an RFS could be given by its own identity, plus the identity of its parent(s), here RFSC, CFS, and/or UE. This could be denoted as a Fully Distinguished Name (FDN) and apart from providing a global unique identity, the FDN also indicates any relations between RFSs given by one or more common parents. The examples above could also be combined to provide an accurate RFS identity. An explicit UEid may be needed if it is not deducible via other information related to the CFS, the RFSC, or the RFS that they are consumed by the same UE. The UEid may be denoted Userld or similar, under the assumption that the user uses one UE.

In the example shown in FIG. 7(a) this would correspond to the following RFS identities:

FDN(RFS1)=CFSid+RFS1id

FDN(RFS2)=CFSid+RFS2id

In middle example shown in FIG. 7(b) this would correspond to the following RFS identities:

FDN(RFS1)=CFSid+RFSCid+RFS1id

FDN(RFS2)=CFSid+RFSCid+RFS2id

Assuming a known one-to-one relation between CFS and the RFSC in the example shown in FIG. 7(b), the unique identities could be shortened as given below, which could be denoted as a Relative Distinguished Name (RDN).

RDN(RFS1)=RFSCid+RFS1id

RDN(RFS2)=RFSCid+RFS2id

In the example shown in FIG. 7(c) this would correspond to the following RFS identities.

FDN(RFS1)=UEid+CFS1id+RFS1id

FDN(RFS2)=UEid+CFS2id+RFS2id

And following the teaching of the description of FIG. 7(b) the identities in FIG. 7(c) could be shortened as shown below, still carrying information allowing correlation of the two RFSs.

FDN(RFS1)=UEid+RFS1id

FDN(RFS2)=UEid+RFS2id

FIGS. 7(a) to 7(c) relate to the provisioning phase, when creating and configuring a network slice and network slice subnet is carried out. To ensure that UEs using either, or both, RFS1 and RFS2 are always connected to the same control plane entities, information on how the RFS1 and RFS2 are related is conveyed via the FDN/RDN. In different embodiments the control plane entities may be deployed as virtual network functions, VNF, (i.e. software) or as physical network functions (hardware and software). Ultimately it guides the NSSMF to configure the control plane nodes to carry both RFS1 and RFS2 and not divide them between nodes. In FIGS. 7(a) and 7(b) it is implicitly understood that the CFS is consumed by a UE. In FIG. 7(c) it is explicit that a UE consumes both CFSs.

Considering the relations among customer facing services and resource facing services and the shortcomings of the solutions defined in current standard specifications, i.e. not being able to configure multiple slices to be associated with the same UE, the present disclosure proposes the following solution, illustrated in FIG. 8:
The FDN or RDN for a service is provided in the AllocateNsi() message sent by the CSMF, 602, when creating a ServiceProfile, and then the NSMF, 604, may decide whether to create a new NSI or reuse an existing NSI.
The FDN or RDN for a service is provided in the AllocateNssi() message sent by the NSMF, 604, when creating a SliceProfile, and then the NSSMF, 606, may decide whether to create a new NSSI or reuse an existing NSSI.
The FDN or RDN of a service may be modelled as part of the ServiceProfile and SliceProfile as discussed in more detail below.
Advantageously, in embodiment of this solution multiple ServiceProfiles and SliceProfiles may be part of the allocation request. Collectively, in this document the messages AllocateNsi() and AllocateNssi() may be referred to as an allocation request.

In preferred embodiments, a SliceProfile is derived from a ServiceProfile. For example, if the ServiceProfile describes requirements on an end-to-end service, then the NSMF may translate those requirements into SliceProfiles for the radio access network (RAN), transport network (TN) and core network (CN) and use this information in AllocateNSSI() messages to NSSMFs for respective RAN, TN and CN.

In an alternative embodiment, illustrated in FIG. 9, if only one ServiceProfile or SliceProfile is provided in a modification request, a ModifyNsi and ModifyNssi procedures may be used to add additional Service Profiles and Slice Profiles to an existing NSI or NSSI respectively. The term modification request collectively refers to ModifiNsi() and ModifiNssi() messages. The present disclosure proposes the following solution, illustrated in FIG. 9:
The FDN or RDN for a service is provided, 902, in the modifiNsi() message from the CSMF, 602, when adding a ServiceProfile, where the NSMF enforces the request on an existing NSI in order to modify the NSI.
The FDN or RDN for a service is provided, 904, in the modifiNssi() message when adding a SliceProfile, where the NSSMF enforces the request on an existing NSSI.
The FDN or RDN of a service is modelled as part of the ServiceProfile and SliceProfile as discussed in more detail below.
Multiple ServiceProfiles and SliceProfiles may be part of the modification request as shown in FIG. 9.
In a preferred embodiment an identifier of the NSI or NSSI to be modified may also be provided in the request. This is because when a service is to be modified the NSI and NSSI associated with the service to be modified are known and in in consequence the CSMF, 602, and NSMF, 604, may include the known identifiers for NSI and NSSI respectively.

3GPP TS 28.531 does not explicitly specify the ModifyNsi and ModifyNssi operations. The ModifyNsi or ModifyNssi procedures, mentioned in 3GPP TS28.531 subclause 7.6 and 7.7, use the modifyMOIattributes operation defined in 3GPP TS28.532. The object of the solution disclosed herein is to provide a new ServiceProfile and SliceProfile (both defined by key-value pairs mentioned earlier) as part of a modification requests, i.e. modifyNSI(NSIid, ServiceProfile) and modifyNSSI(NSSIid, SliceProfile). These new ServiceProfile/SliceProfile will be based on the NSI/NSSI identities and the FDN/RDN in the ServiceProfile/SliceProfile. In 3GPP standard specifications the NSIid/NSSIid (i.e. NSI/NSSI identities) are returned by the allocation requests, allocateNSI() and allocateNSSI() respectively. The key-value pairs (attribute name/attribute value) are specified in 3GPP 28.531 and 3GPP TS 28.541. The modifyMOIattributes operation takes the distinguished name (DN) of the MO to be modified as input. Since the allocateNSI and allocateNSSI operations only return the identity of the NSI/NSSI allocated, it is not possible for the consumer requesting the allocation to modify the NSI/NSSI using the modifyMOIattributes operation. It is proposed to add the DN of the NSI/NSSI as part of the result from the allocateNSFallocateNSSI to solve this issue.

For AllocateNsi, AllocateNssi, ModifyNsi and ModifyNssi procedures discussed above the FDN and RDN may be modelled as part of the ServiceProfile and SliceProfile. The ServiceProfile and SliceProfile may be represented as a data type and contain the service FDN or RDN as indicated below:

```
ServiceProfile {
  service <FDN|RDN>
  ...
}
SliceProfile {
  service <FDN|RDN>
  ...
}
```

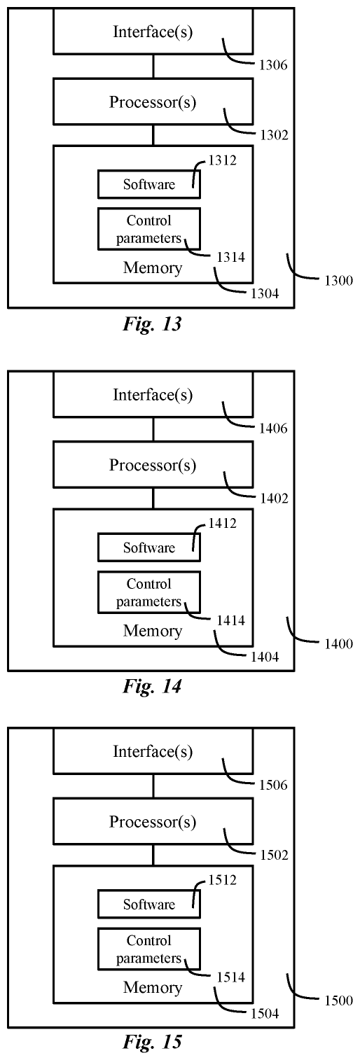

FIG. 13 illustrates one embodiment of a first network element, 1300, for implementing a network slice management function (NSMF) which implements the method described earlier with reference to FIG. 10. The first network element, 1300, comprises a processing circuitry, 1302, and a memory, 1304. The memory, 1304, contains instructions executable by the processing circuitry, 1302, such that the first network element, 1300, is operative to receive from a communications service management function (CSMF) a first message requesting an operation on at least one network slice instance (NSI). In a preferred embodiment the first message comprises attributes and their values defining at least one service profile. The first network element, 1300, is further operative to send to a network slice subnet management function (NSSMF) a second message requesting an operation on at least one network slice subnet instance (NSSI). Preferably, the second message comprises attributes and their values defining at least one slice profile. The at least one slice profile is based on attributes and their values defining profiles of at least one customer facing service (CFS) and at least one resource facing service (RFS) associated with said at least one customer facing service (CFS).

The memory, 1304, may include software, 1312, and/or control parameters, 1314. The memory, 1304, may include suitably configured program code to be executed by the processor(s), 1302, so as to implement the above-described method as explained in connection with FIG. 10.

FIG. 14 illustrates one embodiment of a second network element, 1400, for implementing a communications service management function (CSMF) which implements the method described earlier with reference to FIG. 11. The second network element, 1400, comprises a processing circuitry, 1402, and a memory, 1404. The memory, 1404, contains instructions executable by the processing circuitry, 1402, such that the second network element, 1400, is operative to send to a network slice management function (NSMF) a first message requesting an operation on at least one network slice instance (NSI). Preferably, the first message comprises attributes and their values defining at least one customer facing service (CFS) and at least one resource facing service (RFS) associated with said at least one customer facing service (CFS).

The memory, 1404, may include software, 1412, and/or control parameters, 1414. The memory, 1404, may include suitably configured program code to be executed by the processor(s), 1402, so as to implement the above-described method as explained in connection with FIG. 11.

FIG. 15 illustrates one embodiment of a third network element, 1500, for implementing a network slice subnet management function (NSSMF) which implements the method described earlier with reference to FIG. 12. The third network element, 1500, comprises a processing circuitry, 1502, and a memory, 1504. The memory, 1504, contains instructions executable by the processing circuitry, 1502, such that the third network element, 1500, is operative to receive from a network slice management function (NSMF) a second message requesting an operation on at least one network slice subnet instance (NSSI). Preferably, the second message comprises attributes and their values defining at least one slice profile. The at least one slice profile is based on attributes and their values defining profiles of at least one customer facing service (CFS) and at least one resource facing service (RFS) associated with said at least one customer facing service (CFS). The third network element, 1500, is further operative to perform the requested operation on the at least one network slice subnet instance (NSSI) using the attributes and their values defining the at least one slice profile identified in the second message.

The memory, 1504, may include software, 1512, and/or control parameters, 1514. The memory, 1504, may include suitably configured program code to be executed by the processor(s), 1502, so as to implement the above-described method as explained in connection with FIG. 12.

In preferred embodiments the first, second and third network elements, 1300, 1400 and 1500, may include a processing circuitry (one or more than one processor), 1302, 1402 and 1502, coupled to an interface, 1306, 1406 and 1506, and to the memory 1304, 1404 and 1504. The first, second and third network elements, 1300, 1400 and 1500, may comprise more than one interface. For example, one interface may be for connecting to other network elements, and another interface may be provided for the network operator to perform management operations on the network elements, 1300, 1400 and 1500. By way of example, the interface 1306, 1406 and 1506, the processor(s) 1302, 1402 and 1502, and the memory 1304, 1404 and 1504 may be connected in series as illustrated in FIGS. 13, 14 and 15. Alternatively, these components 1302, 1402, 1502, 1304, 1404, 1504, 1306, 1406 and 1506 may be coupled to an internal bus system of their respective network elements, 1300, 1400 and 1500. The memory 1304, 1404 and 1504 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like.

It is to be understood that the structures as illustrated in FIGS. 13, 14 and 15 are merely schematic and that the network elements, 1300, 1400 and 1500 may actually include further components which, for the sake of clarity, have not been illustrated, e.g., further interfaces or processors. Also, it is to be understood that the memory, 1304, 1404 and 1504, may include further program code for implementing other and/or known functionalities.

According to some embodiments, also a computer program may be provided for implementing functionalities of the network elements, 1300, 1400 and 1500, e.g., in the form of a physical medium storing the program code and/or other data to be stored in the memory 1304, 1404 and 1504, or by making the program code available for download or by streaming.

It is also to be understood that the network elements, 1300, 1400 and 1500, may be provided as a virtual apparatus. In one embodiment, the network elements, 1300, 1400 and 1500, may be provided in distributed resources, such as in cloud resources. When provided as virtual apparatus, it will be appreciated that the memory, processing circuitry, interface(s) may be provided as functional elements. The functional elements may be distributed in a logical network and not necessarily be directly physically connected. It is also to be understood that the network elements, 1300, 1400 and 1500 may be provided as single-node devices, or as a multi-node system.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form. Some embodiments may be represented as a non-transitory software product stored in a machine-readable medium (also called a computer-readable medium, a processor-readable medium, or a computer usable medium having a computer-readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

It should be noted that the above-mentioned examples illustrate rather than limit the disclosure, and that those skilled in the art will be able to design many alternative embodiments without departing from the scope of this document. The word “comprising” does not exclude the presence of elements or steps other than those mentioned in description of embodiments, “a” or “an” does not exclude a plurality, and a single processor or other unit may fulfil the functions of several units recited in this document.

### ABBREVIATIONS

3GPP Third Generation Partnership Program

CFS Customer Facing Service

CSI Communication Service Instance

CSMF Communications Service Management Function

FDN Fully Distinguished Name

NRM Network Resource Model

NS Network Slice

NSI Network Slice Instance

NSSI Network Slice Subnet Instance

NSMF Network Slice Management Function

NSSMF Network Slice Subnet Management Function

RDN Relative Distinguished Name

RFS Resource Facing Service

RFSC Resource Facing Service Composite

TMF Telecom Management Forum

UE User Equipment

WD Wireless Device

### REFERENCES

TMF GB922 Service Overview, Release 19.0.1

3GPP TS 28.541 V16.3.0

3GPP TS 28.530 V16.1.0

3GPP TS 28.531 V16.4.0

3GPP TS 28.532 V16.2.0

3GPP TR 28.805 V16.1.0

1. A method of provisioning a communication service instance to a customer, the method performed at a network slice management function comprising:
receiving, from a communications service management function, a first message requesting an operation on at least one network slice instance, the first message comprising attributes and their values defining at least one service profile; and
sending, to a network slice subnet management function, a second message requesting an operation on at least one network slice subnet instance, the second message comprising attributes and their values defining at least one slice profile, wherein the at least one slice profile is based on attributes and their values defining profiles of at least one customer facing service, and at least one resource facing service associated with said at least one customer facing service.

2. The method according to claim 1, wherein the requested operation on a network slice instance, comprises an operation of allocating a new network slice instance or an operation of modifying an existing network slice instance.

3. The method according to claim 1, wherein the requested operation on a network slice subnet instance, NSSI, comprises an operation of allocating a new network slice subnet instance or an operation of modifying an existing network slice subnet instance.

4. The method according to claim 1, wherein the first message comprises attributes and their values defining at least one customer facing service, and at least one resource facing service, associated with said at least one customer facing service.

5. The method according to claim 4, wherein said first message further comprises an identifier indicative of a User Equipment consuming said at least one customer facing service, and its associated at least one resource facing service.

6. The method according to claim 1, wherein the at least one slice profile is also based on an identifier indicative of a User Equipment consuming said at least one customer facing service, and its associated at least one resource facing service.

7. A method of provisioning a communication service instance to a customer, the method being performed at a communications service management function and comprising:
sending, to a network slice management function, a first message requesting an operation on at least one network slice instance, the first message comprising attributes and their values defining at least one customer facing service, and at least one resource facing service, associated with said at least one customer facing service.

8. The method according to claim 7, wherein said first message further comprises an identifier indictive of a User Equipment consuming said at least one customer facing service, and its associated at least one resource facing service.

9. (canceled)

10. A method of provisioning a communication service instance to a customer, the method being performed at a network slice subnet management function, and comprising:
receiving, from a network slice management function, a second message requesting an operation on at least one network slice subnet instance, the second message comprising attributes and their values defining at least one slice profile, wherein the at least one slice profile is based on attributes and their values defining profiles of at least one customer facing service and at least one resource facing service associated with said at least one customer facing service; and
performing the requested operation on the at least one network slice subnet instance, using the attributes and their values defining the at least one slice profile identified in the second message.

11. The method according to claim 10, wherein the requested operation on a network slice subnet instance, NSSI, comprises an operation of allocating a new network slice subnet instance or an operation of modifying an existing network slice subnet instance.

12. (canceled)

13. A first network element for implementing a network slice management function, NSMF, the first network element comprising a processing circuitry and a memory, the memory containing instructions executable by the processing circuitry such that the first network element is operative to:
receive, from a communications service management function, a first message requesting an operation on at least one network slice instance, the first message comprising attributes and their values defining at least one service profile; and
send, to a network slice subnet management function, a second message requesting an operation on at least one network slice subnet instance, the second message comprising attributes and their values defining at least one slice profile, wherein the at least one slice profile is based on attributes and their values defining profiles of at least one customer facing service, and at least one resource facing service, associated with said at least one customer facing service.

14. The first network element according to claim 13, wherein in the requested operation on a network slice instance, the first network element is operative to allocate a new network slice instance or to modify an existing network slice instance.

15. The first network element according to claim 13, wherein in the requested operation on a network slice subnet instance, the first network element is operative to allocate a new network slice subnet instance or to modify an existing network slice subnet instance.

16. The first network element according to claim 13, wherein the first message comprises attributes and their values defining at least one customer facing service, and at least one resource facing service associated with said at least one customer facing service.

17. (canceled)

18. The first network element according to claim 13, wherein the at least one slice profile is also based on an identifier indicative of a User Equipment consuming said at least one customer facing service, and its associated at least one resource facing service.

19. A second network element for implementing a communications service management function, the second network element comprising a processing circuitry and a memory, the memory containing instructions executable by the processing circuitry such that the second network element is operative to:
send, to a network slice management function, a first message requesting an operation on at least one network slice instance, the first message comprising attributes and their values defining at least one customer facing service, and at least one resource facing service, associated with said at least one customer facing service.

20. The second network element according to claim 19, wherein said first message further comprises an identifier indictive of a User Equipment consuming said at least one customer facing service, and its associated at least one resource facing service.

21. The second network element according to claim 19, wherein the requested operation on a network slice instance, comprises an operation of allocating a new network slice instance or an operation of modifying an existing network slice instance.

22. A third network element for implementing a network slice subnet management function, the third network element comprising a processing circuitry and a memory, the memory containing instructions executable by the processing circuitry such that the third network element is operative to:
receive, from a network slice management function, a second message requesting an operation on at least one network slice subnet instance, the second message comprising attributes and their values defining at least one slice profile, wherein the at least one slice profile is based on attributes and their values defining profiles of at least one customer facing service, and at least one resource facing service, associated with said at least one customer facing service; and
perform the requested operation on the at least one network slice subnet instance, using the attributes and their values defining the at least one slice profile identified in the second message.

23. The third network element according to claim 22, wherein the requested operation on a network slice subnet instance, comprises an operation of allocating a new network slice subnet instance or an operation of modifying an existing network slice subnet instance.

24. The third network element according to claim 22, wherein the at least one slice profile is also based on an identifier indicative of a User Equipment consuming said at least one customer facing service, and its associated at least one resource facing service.

25-28 (canceled)

29. A method of provisioning a communication service instance to a customer, the method being performed at a network slice management function, and comprising:
receiving, from a communications service management function, a third message requesting an operation on at least one existing network slice instance, the third message comprising attributes and their values defining at least one service profile to be associated with the at least one existing network slice instance;
associating the at least one service profile with the at least one existing network slice instance; and
sending, to a network slice subnet management function, a fourth message requesting an operation on at least one existing network slice subnet instance, the fourth message comprising attributes and their values defining at least one slice profile to be associated with the at least one existing network slice subnet instance, wherein the at least one slice profile is based on attributes and their values defining profiles of at least one customer facing service, and at least one resource facing service, associated with said at least one customer facing service.

30. (canceled)
